(19) United States
(12) Patent Application Publication
(10) Pub. No.: US 2021/0187617 A1
(43) Pub. Date: Jun. 24, 2021

(54) METHOD AND APPARATUS FOR MANUFACTURING A THREE-DIMENSIONAL OBJECT

(71) Applicant: EOS GmbH Electro Optical Systems, Krailling OT (DE)

(72) Inventors: Nikolai Zaepernick, Eurasburg (DE); Peter Keller, Krailling (DE); Florian Pfefferkorn, München (DE); André Danzig, Lindenberg (DE); Andreas Pfister, München (DE)

(73) Assignee: EOS GmbH Electro Optical Systems, Krailling, OT (DE)

(21) Appl. No.: 16/087,390

(22) PCT Filed: Mar. 22, 2017
(86) PCT No.: PCT/EP2017/056892

§ 371 Date: Sep. 21, 2018

(30) Foreign Application Priority Data
Mar. 23, 2016 (DE) 10 2016 204 905.4

(51) Int. Cl. B22F 10/50; B22F 10/28; B33Y 10/00; B33Y 30/00; B33Y 40/20

(52) U.S. Cl. CPC B22F 10/50; B22F 10/28; B33Y 10/00; B22F 2202/06; B33Y 40/20; B22F 2202/05; B33Y 30/00

(57) ABSTRACT

Method for manufacturing a three-dimensional object by layer-wise application and selective solidification of a building material with the step of applying a layer of the building material on a building base within a build area and with the step of selectively solidifying the applied layer by solidifying an area of the applied layer which corresponds to the cross-section of the object in the layer in order to produce a solidified area in the layer. The steps of applying and selectively solidifying are repeated until the three-dimensional object is completed. At least once during manufacturing the three-dimensional object, a sub-area that is only a predetermined portion of the solidified area is after-treated. The sub-area is located substantially inside the solidified area.

The present invention relates to a method and an apparatus for manufacturing a three-dimensional object by layer-wise and selective solidification of a building material.

Methods and apparatuses of this type are, for instance, used for rapid prototyping, rapid tooling, and additive manufacturing. An example of such a method is known as “selective laser sintering” or “selective laser melting”. Herein, a thin layer of building material in powder form is repeatedly applied within a build area and the building material in each layer is selectively solidified by irradiation using a laser beam, i.e. building material is partially or completely melted at these positions and solidifies forming a solid material.

Document DE 195 14 740 C1 describes a method for manufacturing a three-dimensional object by use of laser sintering or laser melting as well as an apparatus for carrying out this method.

In many cases, it is very arduous or impossible to manufacture a three-dimensional object with the desired properties exclusively through layer-wise application and selective solidification of a building material.

In document DE 10 2009 051 551 A1, a generative manufacturing method for the layer-wise construction of an object is disclosed, wherein a laser-induced or plasma-induced application of pressure to layers of the object is performed for an increase of the strength and a reduction of the micro-porosity.

In document WO 2013/127655 A1, a method for manufacturing a three-dimensional object through solidifying a powder in layer-wise manner is described, wherein at least a not precisely defined sub-area of a layer is heated by use of an electron beam in order to improve the mechanical properties of the layer.

Document DE 10 2012 014 841 A1 shows an apparatus for the manufacture of three-dimensional objects through solidifying a building material in layer-wise manner by using electromagnetic radiation, wherein the apparatus comprises a grinding device for smoothing areas of a layer which are already solidified.

Document DE 100 28 063 A1 discloses a method for the manufacture of a workpiece by layer-wise solidification of a building material by use of electromagnetic radiation, wherein the lateral periphery of a solidified material layer is subjected to a hobbing treatment according to the final shape of the workpiece.

It is an object of the present invention to provide an improved method or an improved apparatus for manufacturing a three-dimensional object by layer-wise application and selective solidification of a building material. In this respect, it is particularly preferred to be able to rapidly and/or effectively let the part have particular component characteristics.

The object is achieved by a method according to claim 1, a method according to claim 2, a computer program according to claim 13, a control device according to claim 14, and an apparatus according to claim 15. The features specified in the dependent claims of one claim category and the features which are related to the subject-matter belonging to one claim category and which are elucidated below in the description may also be understood as a refinement of the subject-matter of each other claim category.

The inventive method according to one embodiment of the invention is a method for manufacturing a three-dimensional object by layer-wise application and selective solidification of a building material. The method comprises the step of applying a layer of the building material within a build area. The method comprises the step of selectively solidifying the applied layer by solidifying an area of the applied layer which corresponds to the cross-section of the object in the layer in order to produce a solidified area in the layer. The steps of applying and selectively solidifying are repeated until the three-dimensional object is completed. Herein, at least once during manufacturing the three-dimensional object, a sub-area that is only a predetermined portion of the solidified area (in particular also hereinafter: a predetermined portion of the previously solidified area) is after-treated, wherein the sub-area is located substantially inside the solidified area. In this way, for instance, it becomes possible to effect the modification of a property in a sub-area inside the three-dimensional object, which is not accessible for after-treatment of the completed three-dimensional object, wherein the size of this sub-area, its position within the three-dimensional object, as well as the nature and extent of the modification of the material property are predetermined.

The inventive method according to another embodiment of the invention is a method for manufacturing a three-dimensional object by layer-wise application and selective solidification of a building material. The method comprises the step of applying a layer of the building material within a build area. The method comprises the step of selectively solidifying the applied layer by solidifying an area of the applied layer which corresponds to the cross-section of the object in the layer in order to produce a solidified area in the layer. The steps of applying and selectively solidifying are repeated until the three-dimensional object is completed. At least once during manufacturing the three-dimensional object, a sub-area that is only a predetermined portion of the solidified area, is after-treated, wherein a material property is modified in the sub-area by the after-treatment. In this way, for instance, a three-dimensional object may be manufactured which in at least one zone exhibits a material property being modified compared to another zone.

Preferably, a first command data set is executed for solidifying the area and a second command data set is executed for after-treating the sub-area, wherein coordinate data underlie the second command data set which also underlie the first command data set. This ensures, for instance, that the predetermined position of the after-treated sub-area in the solidified area can be accurately complied with.

Preferably, the material property is an electric material property, which is in particular the electric conductivity, and/or an optical material property, which is in particular the color and/or the absorption strength and/or the optical transparency, and/or a magnetic material property and/or a mechanical material property, which is in particular the material hardness, and/or the spatial orientation of particles. This makes it possible, for instance, to manufacture a three-dimensional object which has in one zone a higher electric conductivity and/or a higher magnetic moment and/or a higher optical transparency compared to another zone. A possible approach within the scope of this preferred embodiment of the invention is explained in detail below on the basis of a selected example:

In the step of selectively solidifying, only a relatively small amount of energy is introduced such that the building material—in the present case and by way of example, a building material in powder form—is only slightly fused. This results in a relatively high porosity and therefore only a low stiffness or strength, respectively, of the three-dimensional object at the selectively solidified positions. In the course of the after-treatment within the scope of the invention, energy is then introduced once again such that the fusion of the powder is now better and such that the object obtains a higher stiffness or strength at the selected after-treated positions. A preferred case of application of the approach according to this example is the application to flexible plastics, e.g. thermoplastic elastomers.

As an alternative or in addition, solidified material is removed in the sub-area by the after-treatment. In this way, for instance, a three-dimensional object may be manufactured which has small cavities with predetermined size, shape, and position within in its interior.

Herein, preferably, a building material in powder form is used which comprises a first powder component and a second powder component, wherein the two powder components are different from each other with respect to their material properties, wherein the second powder component comprises powder grains which are substantially granulated in a significantly finer way compared to the first powder component. The method comprises the step of removing the solidified material in the sub-area such that in the sub-area holes and/or grooves are generated that are narrower than a grain size of the first powder component. The method further comprises the step of applying the building material at least in the sub-area such that substantially exclusively the second powder component can get into the holes and/or grooves. In this way, for instance, it is possible to manufacture a three-dimensional object which consists of a first material (generated by solidifying both powder components), in which zones of a different material (made of the second powder component) are embedded at predetermined positions.

Preferably, a radiation is used for the after-treatment of the sub-area, wherein the radiation differs from the radiation used for solidifying the area, in particular with respect to its constituents and/or its wavelength and/or its intensity and/or its power density. In this way, it is for instance possible to effectuate physical and/or chemical transformations by the after-treatment which cannot be effectuated by a radiation that is used for solidifying the area.

Preferably, an electric conductor, in particular a metallic conductor, is generated by the after-treatment in the sub-area. In this way, for instance, electrically conductive passages can be generated in a three-dimensional object which otherwise consists of an electric insulator.

Herein, preferably, a material with at least one electric conductor component and at least one electric insulator component is used as building material. The electric insulator component is at least partially separated from the electric conductor component in at least the sub-area. In the course of the after-treatment, the electric conductor component is joined, in particular partially and/or completely melted in the sub-area forming an electric conductor. In this way, it is possible for instance, to generate complex three-dimensional conductive structures in a simple way.

In this context, it is preferred that the melting point or melting range of the electric conductor component is below the decomposition temperature of the insulator component and preferentially only insignificantly (i.e. in particular a temperature difference of not more than 10%, preferably 5% in K and/or increased by not more than 50 K, preferably 25 K), above the melting range or melting point of the insulator component. For instance, the decomposition temperature may be determined by use of a thermogravimetric method according to ISO 11358 (ISO 11358-1:2014, ISO 11358-2:2014, ISO 11358-3:2013).

Preferably, a powder that contains particles consisting of an electric conductor which are coated with an electric insulator is used as building material. In this way, it is for instance possible to apply a layer of a building material in one step, wherein the building material consists of both an electrically insulating and an electrically conductive component, and to solidify the building material such that an electrically insulating solid material is generated in which electrically conductive particles are embedded, and to bring these electrically conductive particles into contact with each other through an after-treatment by use of irradiation with an electromagnetic radiation in a sub-area of the solidified area such that an electrically conductive sub-area is formed.

In this context, it is preferred that the electric insulator is removed through the after-treatment of the layer, preferably substantially without residue. Further, it is preferred that the particles consisting of the electric conductor are melted through the after-treatment simultaneously with the disappearance of the electric insulator.

Preferably, at least during the after-treatment, the sub-area is exposed to the influence of a magnetic and/or electric and/or electromagnetic field. In this way, it is for instance possible to align embedded particles or fibers in the applied field such that they have a preferred orientation in the manufactured three-dimensional object.

Preferably, for the after-treatment, a substance being different from the building material is applied in at least the sub-area and more preferably activated after the application. In this way, for instance, a substance may be applied which undergoes a chemical reaction with the previously solidified building material in the sub-area by way of which a material property in the sub-area is modified.

The inventive computer program may be loaded into a programmable control device and comprises a program code in order to carry out all steps of an inventive method when the computer program is executed on a control device. In this way, for instance, it is possible to carry out the inventive method in a computerized way.

The inventive control device is a control device for an apparatus for manufacturing a three-dimensional object by layer-wise application and selective solidification of building material. The control device is configured to control the apparatus such that it applies a layer of building material within a build area, selectively solidifies the applied layer by solidifying an area of the applied layer corresponding to the cross-section of the object in the layer in order to generate a solidified area in the layer, repeats the application and selective solidification until the three-dimensional object is completed, and after-treats a sub-area that is only a predetermined portion of the solidified area at least once during the manufacture of the three-dimensional object. Herein, the sub-area is located substantially inside the solidified area and/or a material property is modified in the sub-area through the after-treatment. In this way, for instance, a control device is provided which has the ability to control an apparatus for manufacturing a three-dimensional object such that it automatically carries out the inventive method.

The inventive apparatus is an apparatus for manufacturing a three-dimensional object by layer-wise application and selective solidification of a building material. The apparatus is configured to be controlled (in particular by the inventive control device) such that it applies a layer of building material within a build area, selectively solidifies the applied layer by solidifying an area of the applied layer corresponding to the cross-section of the object in the layer in order to generate a solidified area in the layer, repeats the application and selective solidification until the three-dimensional object is completed, and after-treats a sub-area that is only a predetermined portion of the solidified area at least once during the manufacture of the three-dimensional object, wherein the sub-area is located substantially inside the solidified area and/or a material property is modified in the sub-area through the after-treatment. In this way, for instance, an apparatus is provided with which the inventive method can be carried out.

Further features and expediences of the invention follow from the description of embodiments of the inventive apparatus with reference to the appended drawings.

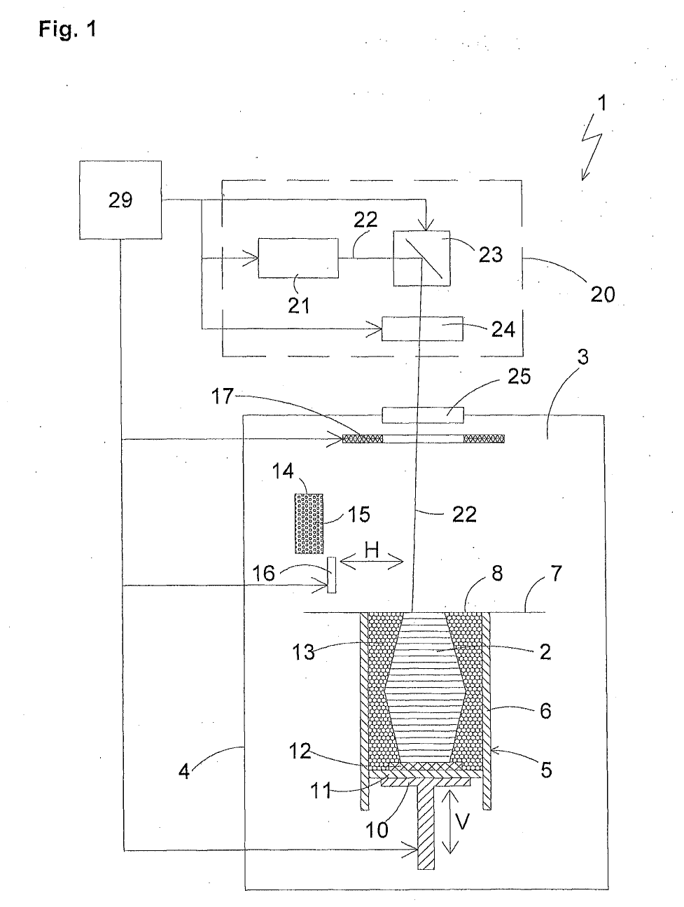

FIG. 1 is a schematic view, shown as vertical cross-section, of an apparatus for manufacturing a three-dimensional object in a layer-wise manner according to an embodiment of the present invention.

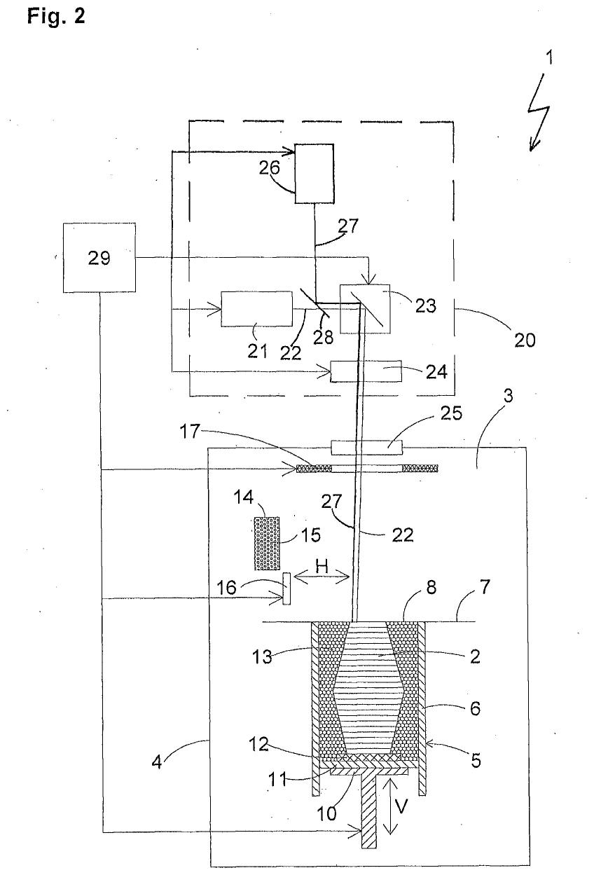

FIG. 2 is a schematic view, shown as vertical cross-section, of an apparatus for manufacturing a three-dimensional object in a layer-wise manner according to another embodiment of the present invention.

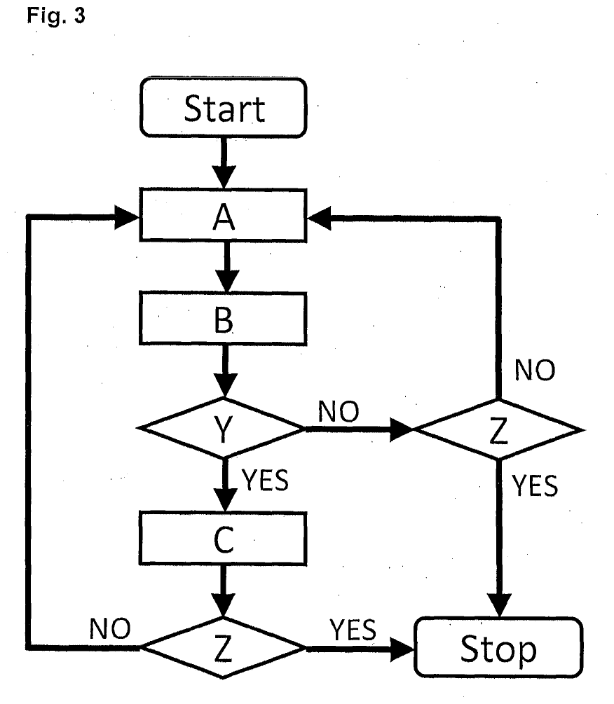

FIG. 3 is a flowchart of a method according to an embodiment of the invention.

The apparatus shown in FIG. 1 is a laser sintering or laser melting apparatus 1 for manufacturing an object 2.

The apparatus 1 includes a process chamber 3 with a chamber wall 4. In the process chamber 3, a container 5 being open at the top having a container wall 6 is arranged. A working plane 7 is defined by the upper opening of the container 5, wherein the area of the working plane 7 that lies within the opening and which can be used for the construction of the object 2 is referred to as build area 8. A support, to which a base plate 11, which closes the container towards its underside and therefore forms its bottom, is attached, which can be moved in a vertical direction V, is arranged in the container 5. The base plate 11 may be a plate which is formed separately from the support 10 and which is fastened to the support 10 or it may be formed monolithically with the support 10. Depending on the powder used and the process used, a building platform 12, on which the object 2 is built, may be attached to the base plate 11 as building base. The object may also be built on the base plate 11 itself, which then serves as building base. In FIG. 1, the object to be formed is shown in an intermediate state. It consists of a plurality of solidified layers and is surrounded by non-solidified building material 13.

The apparatus 1 further contains a storage container 14 for building material 15 in powder form, which can be solidified by electromagnetic radiation, and a recoater 16, which is movable in a horizontal direction H, for applying layers of the building material 15 within the build area 8. Optionally, a radiation heater 17, which serves to heat the applied building material 15, is arranged in the process chamber 3. As radiation heater 17, for instance an infrared emitter, may be provided.

The apparatus 1 further comprises an irradiation device 20 with a laser 21, which generates a laser beam 22, which is deflected by a deflecting device 23 and focused onto the working plane 7 by a focusing device 24 via a coupling window 25, which is arranged at the top of the process chamber 3 in the chamber wall 4.

Further, the apparatus 1 comprises a control device 29 by way of which the individual component parts of the apparatus 1 are controlled in a coordinated manner for executing the process for manufacturing a three-dimensional object. The control device 29 may comprise a CPU, the operation of which is controlled by a computer program (software). The computer program may be stored on a storage medium being separate from the apparatus 1, from which it may be loaded into the apparatus 1, in particular in the control device 29.

For controlling the apparatus 1, the control device 29 executes command data sets. For a certain layer of the three-dimensional object 2, a first command data set is herein based on the coordinates (X, Y) of the positions which correspond to the area to be solidified in this layer and which therefore correspond to the cross-section of the three-dimensional object 2. When the first command data set for a certain layer is executed, the area is solidified. For a certain layer of the three-dimensional object 2, a second command data set is based on the coordinates (X, Y) of the positions which correspond to the sub-area of the solidified area in this layer to be after-treated. Because the sub-area to be after-treated is a sub-area of the solidified area, the set of coordinates underlying the second command data set is a subset of the set of coordinates underlying the first command data set. The coordinates underlying the command data sets are in practice typically calculated by a computer program from a computer model (e.g. a CAD model) of the object to be manufactured.

In the apparatus 1 according to the embodiment shown in FIG. 2, a further radiation source 26, which emits a beam 27, is provided in the irradiation device 20 in addition to the laser 21. The beam 27 is guided to the deflecting device 23 by a deflector 28. The beam 27 is guided from the deflecting device 23 through the focusing device 24 via the coupling window 25 to the positions of the solidified area which are to be after-treated. In the context of the invention, it is also possible that an individual deflecting device and/or an individual focusing device and/or an individual coupling window is provided for each of beam 27 and beam 22. For reasons of clarity, both beams 22 and 27 are drawn in FIG. 2, although, preferably, these beams are not simultaneously focused onto the build area 8 in the working plane 7. Preferably, the beam 27 may be a beam of electromagnetic radiation, in particular a laser beam, or a particle beam, in particular an electron beam.

During operation, the support 10 is lowered by a height which preferably corresponds to the desired thickness of the layer of the building material 15 in order to apply a powder layer. First, the recoater 16 moves to the storage container 14 and receives therefrom an amount of building material 15 which is sufficient for applying a layer. Then, it moves over the build area 8 and applies a thin layer of the pulverulent building material 15 on the building base 10, 11, 12 or an already previously present powder layer. The application is done over at least the entire cross-section of the object 2 to be manufactured, preferably over the entire build area 8. Optionally, the building material 15 in powder form is heated to a working temperature by means of the radiation heater 17. Subsequently, the cross-section of the object 2 to be manufactured is scanned by the laser beam 22 such that this area of the applied layer is solidified. These steps are repeated until the object 2 is completed and may be taken out of the container 5.

According to the invention, a sub-area of the solidified area is after-treated at least once during the manufacture of a three-dimensional object 2 (i.e. in at least one layer of the building material 15).

In FIG. 3, the method according to an embodiment of the invention is shown in the form of a flowchart. The operation A represents the step of applying a layer of the building material 15 within a build area 8. The operation B represents the step of selectively solidifying the applied layer. Herein, the selective solidification is carried out through solidifying an area of the applied layer which corresponds to the cross-section of the object in this layer. The operation C represents the after-treatment of a sub-area of the solidified area in the layer. The branch Y represents the decision whether the solidified area (operation B) is to be after-treated or not. The branches Z represent the decision whether the three-dimensional object is completed. The control points “Start” and “Stop” indicate the beginning and ending of the execution of the method.

The after-treatment may be effected in that the positions of the solidified area which are to be after-treated are scanned once again with the laser beam 22. The after-treatment may also be effected by use of a beam 27, which is different from the beam 22, which is applied in order to solidify the area, as shown in the embodiment of FIG. 2. For example, the beam 27 for the after-treatment and the beam 22 for the solidification may consist of different constituents, wherein in particular photons and electrons are considered as constituents. Further, wavelength and/or intensity and/or power density and/or other characteristic features of the beams may be different.

Herein, the after-treatment may be carried out for the most recently selectively solidified layer only. The after-treatment may also be simultaneously carried out for the most recently selectively solidified layer and the layer lying underneath or for the most recently selectively solidified layer and a plurality of layers lying underneath.

For example, by way of the after-treatment, the electric conductivity may be modified in the sub-area which is after-treated.

In a further embodiment of the invention, an electric conductor is generated through after-treatment in a sub-area generated in an area which is electrically insulating after the solidification. Herein, a building material 15 in powder form is used, which contains a component of an electric insulator (“electric insulator component”) and a component of an electric conductor (“electric conductor component”). Herein, it is preferred that the building material 15 consists of metallic particles which are surrounded by an electric insulator, for example a polymer. Highly preferably, the metallic particles are completely surrounded by a polymer layer such that the pulverulent building material 15 contains powder grains which consist of a core of a metallic material and a cover of an electrically insulating plastic material.

For the selective solidification of this powder, an applied layer is scanned by the laser beam 22 such that the cover of the powder grains partially or completely melts and solidifies forming a solid material, wherein the metallic core of the powder grains does not melt. In the solidified area, an electrically insulating solid material is present in which metal particles being substantially separated from one another are embedded such that the solidified area is in total electrically insulating. For the after-treatment of a layer, the sub-area to be after-treated is again irradiated with the laser beam 22 or with a different radiation, preferably with a laser beam 27, which has a higher power density or wavelength than the laser beam 22. For example, the (first) laser beam 22 from a CO₂ laser with a wavelength of substantially 10.6 μm may be used in order to partially or completely melt the cover of the powder grains and, subsequently, it is after-treated with the (second) laser beam 27 of a ytterbium laser with wavelength of substantially 1.03 μm. By use of the irradiation, the solid material formed through solidification and the metal particles embedded therein are partially or completely melted and the insulator component is preferably removed, especially preferably substantially without residue. Upon solidification of the partially melted metal particles or the molten metal formed by melting the metal particles, an electrically conductive solid material is formed in the sub-area.

It is possible to manufacture a three-dimensional object 2 in the described way, wherein the object is electrically conductive only at the predetermined positions which correspond to the after-treated sub-areas. The positioning of these positions within the object 2 and on its surface can be freely chosen such that any topology of electric conductors embedded in an otherwise electrically insulating three-dimensional object is achievable. The three-dimensional object 2 may for instance be the housing of an electrically operated device or the carrier of an electric circuit, wherein electric contacts are guided through the housing or the carrier, respectively. The three-dimensional object 2 can also be a flat or multi-dimensional circuit board. It is, for instance, also possible to manufacture a three-dimensional object 2 with an embedded antenna and/or contacts for a microchip, in particular being invisible from the exterior, whereby for instance a three-dimensional object 2 with a RFID or other encodings may be manufactured.

In a further embodiment of the invention, previously solidified material is removed in the course of the after-treatment in the sub-area, for instance by irradiating the sub-area with the beam 22 used for solidifying or with another beam 27, in order to generate holes in the solidified layer.

Herein, it is preferred to use as building material 15 a powder which contains powder grains of different granulation (grain size). For example, the building material may be composed of two powder components whose powder grains significantly differ from each other with respect to the grain size, i.e. the grain size distributions of the powder components do not or only slightly overlap.

In a solidified layer or in a plurality of solidified layers, holes are generated by ablation, wherein the holes are sufficiently large such that the powder grains of the second powder component at least partially get into the holes, and wherein the holes are sufficiently small such that substantially the grains of the first powder component cannot get into the holes. When the next layer of the building material 15 is applied, substantially exclusively powder of the second powder component gets into the holes. The two powder components differ from each other with respect to a material property, for example, the first powder component may be composed of an electric insulator and the second powder component may be composed of metallic particles such that in the solidified area an electrically insulating solid material is generated when selectively solidifying an applied layer of the building material 15. The metallic particles getting into the holes that are generated by the after-treatment in the solidified area form a metallic conductor in the holes.

It is also possible to generate grooves by ablation into which substantially exclusively powder of the second powder component can get when a layer of the building material 15 is subsequently applied. In this way, long and narrow zones can be generated which have a different material property compared to the surrounding. If, for instance, the second powder component is composed of metallic particles, electrically conductive conducting paths may be generated in this manner. If, for instance, the second powder component consists of glass or another transparent material, light conductors may be generated in this manner.

In a further embodiment of the invention, an optical material property—for instance the color, the absorption strength or the optic transparency (transmissivity)—is modified by the after-treatment in the sub-area to be after-treated. This may for instance be achieved in that opaque solid material that was formed by sintering is melted in the sub-area by way of irradiation of the sub-area with the beam 22 that is used for solidification or with a different beam 27 and in that one lets the material solidify such that a transparent solid material is formed. This may, for instance, also be achieved by applying to the sub-area a substance which is different from the building material 15 and which is embedded in the solidified layer and which thereby colorizes the layer or undergoes a chemical reaction with the layer.

In a further embodiment, a substance being different from the building material is applied, wherein the substance etches previously solidified material in the sub-area.

In the context of the invention, embodiments are possible in which at least the sub-area to be after-treated is exposed to the influence of a field as an alternative to the exposure of the sub-area to be after-treated to a radiation or in addition to the exposure of the sub-area to be after-treated to a radiation. The field may be a magnetic field and/or an electric field and/or an electromagnetic field. The field may be homogeneous or inhomogeneous. The field may be constant or inconstant in time. Magnetic and/or electrically conductive particles or fibers which are embedded in the solidified layer may for instance be aligned according to the field lines of this field. In this way, for instance, sintered parts composed of composites having an increased strength as a consequence of the alignment of fibers as well as magnetized sintered parts may be manufactured.

The after-treatment for the modification of an electric and/or optical and/or magnetic and/or mechanical material property and/or the spatial orientation of particles is carried out in a sub-area of the solidified area which is only a predetermined portion of the solidified area, i.e. not the entire solidified area is after-treated but only a portion thereof, wherein the size, the shape and the position of the portion are predetermined. Preferably, the sub-area is located in the interior of the solidified area. In the context of the invention, it is also possible to carry out the after-treatment in a sub-area which is located in the periphery of the solidified area in order to manufacture a three-dimensional object 2 which has zones on its surface in which the property achieved by way of after-treatment is present. In this way, for instance, an otherwise electrically insulating three-dimensional object 2 may be manufactured which has on its surface an electrically conductive path.

The after-treatment can also be carried out in order to modify a mechanical material property—in particular the material hardness—in a sub-area which is only a predetermined portion of the solidified area. Preferably, a three-dimensional object 2 is thereby manufactured which has zones of increased hardness and/or strength in its interior, which gives the three-dimensional object 2 an overall increased stability.

As far as possible, the individual features of the embodiments described above may be combined with one another in an arbitrary way. Herein, for instance, the after-treatment of a sub-area of the solidified area may be carried out by scanning the sub-area with the beam 22 used for solidifying or with another beam 27 and by the influence of a substance that is different from the building material.

Even if the present invention was described with connection to a laser sintering device or laser melting device, it is not restricted to laser sintering or laser melting. It can be applied to any method of manufacturing a three-dimensional object by layer-wise application and selective solidification of a building material. Herein, the building material can be in powder form as it is the case, for instance, for laser sintering or laser melting. It may also be liquid as it is the case, for instance, for the method known as “stereo lithography”.

The irradiation device for the solidification and the after-treatment may, for instance, comprise one or more gas lasers, solid state lasers or lasers of any other kind, e.g. laser diodes, especially linear irradiators with VCSEL (Vertical Cavity Surface Emitting Laser) or VECSEL (Vertical External Cavity Surface Emitting Laser). In general, as irradiation device, any device may be used with which energy in the form of wave radiation or particle radiation can be selectively applied to a layer of the building material. Instead of a laser, e.g., any other light source, an electron beam, or any other energy source or radiation source may be used that is suitable to solidify the building material. Instead of deflecting a beam, the irradiation may also be carried out with a moveable linear irradiator. The invention can also be applied to the selective mask sintering, in which an expanded light source and a mask are used, or to the high-speed sintering (HSS), in which material is selectively applied to the building material which increases (absorption sintering) or decreases (inhibition sintering) the absorption of radiation at the positions corresponding to the cross-section of the object, wherein it is then irradiated in a non-selective way over a large-area using a moveable linear irradiator.

As building material, amongst others, different kinds of powder may be used, in particular metal powders, plastic powders, ceramic powders, sand, filled or mixed powders.

1. A method for manufacturing a three-dimensional object by layer-wise application and selective solidification of a building material
with the step of applying a layer of the building material within a build area and
with the step of selectively solidifying the applied layer by solidifying an area of the applied layer which corresponds to the cross-section of the object in the layer in order to produce a solidified area in the layer,
wherein the steps of applying and selectively solidifying are repeated until the three-dimensional object is completed,
wherein at least once during manufacturing the three-dimensional object, a sub-area that is only a predetermined portion of the solidified area is after-treated,
wherein the sub-area is located substantially inside the solidified area.

2. A method for manufacturing a three-dimensional object by layer-wise application and selective solidification of a building material
with the step of applying a layer of the building material within a build area and
with the step of selectively solidifying the applied layer by solidifying an area of the applied layer which corresponds to the cross-section of the object in the layer in order to produce a solidified area in the layer,
wherein the steps of applying and selectively solidifying are repeated until the three-dimensional object is completed,
wherein at least once during manufacturing the three-dimensional object, a sub-area that is only a predetermined portion of the solidified area is after-treated,
wherein a material property is modified in the sub-area by the after-treatment.

3. The method according to claim 1,
wherein a first command data set is executed for solidifying the area,
wherein a second command data set is executed for after-treating the sub-area, and
wherein coordinate data underlie the second command data set which also underlie the first command data set.

4. The method according to claims 2,
wherein the material property is the electric conductivity, and/or the color and/or the absorption strength and/or the optical transparency, and/or the material hardness, and/or the spatial orientation of particles.

5. The method according to any of claims 1,
wherein solidified material is removed in the sub-area by the after-treatment.

6. The method according to claim 5,
wherein a building material in powder form is used which comprises a first powder component and a second powder component, wherein the two powder components are different from each other with respect to their material properties,
wherein the second powder component comprises powder grains which are substantially granulated in a significantly finer way compared to the first powder component,
with the steps:
removing the solidified material in the sub-area such that in the sub-area holes and/or grooves are generated that are narrower than a grain size of the first powder component,
applying a further layer of the building material at least in the sub-area such that substantially exclusively the second powder component can get into the holes and/or grooves.

7. The method according to claims 1,
wherein a radiation is used for the after-treatment of the sub-area,
wherein the radiation differs from a radiation used for solidifying the area, with respect to its constituents and/or its wavelength and/or its intensity and/or its power density.

8. The method according to claims 1,
wherein a metallic conductor is generated by the after-treatment in the sub-area.

9. The method according to claim 8,
wherein a material with at least one electric conductor component and at least one electric insulator component is used as building material,
wherein the electric insulator component is at least partially separated from the electric conductor component in at least the sub-area, and
wherein in the course of the after-treatment, the electric conductor component is partially and/or completely melted in the sub-area forming an electric conductor.

10. The method according to claims 1,
wherein a powder that contains particles consisting of an electric conductor which are coated with an electric insulator is used as building material.

11. The method according to claims 1,
wherein the sub-area is, at least during the after-treatment, exposed to the influence of a magnetic and/or electric and/or electromagnetic field.

12. The method according to claim 1,
wherein for the after-treatment, a substance being different from the building material is applied in at least the sub area and activated after the application.

13. A computer program which is loadable into a programmable control device and which comprises a program code in order to carry out all steps of a method according to claims 1 when the computer program is executed on a control device.

14. A control device for an apparatus for manufacturing a three-dimensional object by layer-wise application and selective solidification of building material,
wherein the control device is configured to control the apparatus such that
it applies a layer of building material within a build area,
selectively solidifies the applied layer by solidifying an area of the applied layer corresponding to the cross-section of the object in the layer in order to generate a solidified area in the layer,
repeats the application and selective solidification until the three-dimensional object is completed, and
after-treats a sub-area that is only a predetermined portion of the solidified area at least once during the manufacture of the three-dimensional object,
wherein the sub-area is located substantially inside the solidified area and/or a material property is modified in the sub-area through the after-treatment.

15. An apparatus for manufacturing a three-dimensional object by layer-wise application and selective solidification of a building material,
wherein the apparatus is configured to be controlled, in particular controlled by the control device according to claim 14, such that
it applies a layer of building material within a build area,
selectively solidifies the applied layer by solidifying an area of the applied layer corresponding to the cross-section of the object in the layer in order to generate a solidified area in the layer,
repeats the application and selective solidification until the three-dimensional object is completed, and
after-treats a sub-area that is only a predetermined portion of the solidified area at least once during the manufacture of the three-dimensional object,
wherein the sub-area is located substantially inside the solidified area and/or a material property is modified in the sub-area through the after-treatment.

16. The method according to claim 2,
wherein a first command data set is executed for solidifying the area,
wherein a second command data set is executed for after-treating the sub-area, and
wherein coordinate data underlie the second command data set which also underlie the first command data set.

17. The method according to claim 2,
wherein a radiation is used for the after-treatment of the sub-area,
wherein the radiation differs from a radiation used for solidifying the area with respect to its constituents and/or its wavelength and/or its intensity and/or its power density.

18. The method according to claim 2,
wherein a metallic conductor is generated by the after-treatment in the sub-area.

19. The method according to claim 2,
wherein a powder that contains particles consisting of an electric conductor which are coated with an electric insulator is used as building material.

20. The method according to claim 2,
wherein the sub-area is, at least during the after-treatment, exposed to the influence of a magnetic and/or electric and/or electromagnetic field.

21. The method according to claim 2,
wherein for the after-treatment, a substance being different from the building material is applied in at least the sub-area and activated after the application.

22. A computer program which is loadable into a programmable control device and which comprises a program code in order to carry out all steps of a method according to claim 2 when the computer program is executed on a control device.
